(19) United States
(12) Patent Application Publication
(10) Pub. No.: US 2011/0194616 A1
(43) Pub. Date: Aug. 11, 2011

(54) EMBEDDED VIDEO COMPRESSION FOR HYBRID CONTENTS

(75) Inventors: Haiyan He, Saratoga, CA (US); Johan Gerard Willem Maria Janssen, San Jose, CA (US)

(73) Assignee: NXP B.V., Eindhoven (NL)

(21) Appl. No.: 13/121,920

(22) PCT Filed: Oct. 1, 2009
(86) PCT No.: PCT/IB09/54304

§ 371 Date: Mar. 30, 2011

(30) Foreign Application Priority Data
Oct. 1, 2008 (EP) 08165618.3

(51) Int. Cl. H04N 7/26

(52) U.S. Cl. 375/240.24; 375/E07.2

(57) ABSTRACT

The present application relates to a method for embedded video compression comprising receiving image data. The method comprises compressing the image data into compressed data blocks with a predefined data rate by using a video compression mode. The method comprises compressing the image data into compressed data blocks with the predefined data rate by using a graphic compression mode, wherein the predefined data rate defines a target code size of a compressed data block. The method comprises detecting whether a code size of the data block does not meet the target code size. The method comprises quantizing at least one input pixel of the image data in case a code size of the data block does not meet the target code size. The present application relates also to a method for embedded video decompression, an apparatus for embedded video compression and an apparatus for embedded video decompression. Furthermore the present application relates to a system comprising said apparatus for embedded video compression and said apparatus for embedded video compression and to a computer readable medium having a computer program stored thereon for performing said method for embedded video compression and said method for embedded video decompression.

### TECHNICAL FIELD

The present application relates to a method for embedded video compression comprising receiving image data. The method comprises compressing the image data into compressed data blocks with a predefined data rate by using a video compression mode. The present application relates also to a method for embedded video decompression, an apparatus for embedded video compression and an apparatus for embedded video decompression. Furthermore the present application relates to a system comprising said apparatus for embedded video compression and said apparatus for embedded video compression and to a computer readable medium having a computer program stored thereon for performing said method for embedded video compression and said method for embedded video decompression.

### BACKGROUND OF THE INVENTION

For processing and displaying video streams, several industry compression standards, such as MPEG, H.264, JPEG or the like are well known in the art. A different approach for compressing and decompressing data is the so called embedded video compression or decompression approach.

According to this approach, contrary to the well-known industry compression standards, image data or image content is compressed in small blocks with a constant data rate. Another difference between the respective approaches is that embedded video compression supports random data access within a video frame. In other words, embedded video compression is transparent to the video processing units.

In general, embedded video compression is referred as the compression between image procession units and the memory block. This approach or technique provides for saving memory footprint and bandwidth. In prior art approaches of embedded video compression the technique can be based on delta pulse code modulation (DPCM) and/or Golomb coding.

However, by using the embedded video compression approach, issues may occur if the data to be compressed comprises besides the regular video data other kind of image data, such as graphic data. For instance, the graphic data or graphic content can be generated by a computer. In this case visible artifacts can be spotted even with the same compression data rate. This may reduce the video quality significantly, since normally the controller does not comprise knowledge about the kind of input image data, like video content or graphic content. More particularly, the input data to be processed may also be comprised of hybrid data.

A general approach for compressing different kinds of data, which is known from prior art, for instance for the well-known industry standards, is to employ two parallel compression paths. Both paths may use a different algorithm and the most suitable path for compression can be selected.

From document US 2007/0206867 a system is known which compresses image data using a lossless algorithm and a lossy algorithm. The results of the lossless algorithm and lossy algorithm are compared with each other and the better output is selected. However, this document does not support constant compression ratio. Thus, the technique according to this document is inappropriate for embedded video compression.

### SUMMARY OF THE INVENTION

It is one object of the present application to provide a method for embedded video compression, which improves the video quality in a simple manner. Another object is to prevent or at least to reduce visible artifacts. A further object is to maintain a constant compression data rate.

These and other objects are solved by a method for embedded video compression comprising receiving image data. The method comprises compressing the image data into compressed data blocks with a predefined data rate by using a video compression mode. The method comprises compressing the image data into compressed data blocks with the predefined data rate by using a graphic compression mode, wherein the predefined data rate defines a target code size of a compressed data block. The method comprises detecting whether a code size of the data block does not meet the target code size. The method comprises quantizing at least one input pixel of the image data in case a code size of the data block does not meet the target code size.

The method according to the present application is used for video embedded compression of image data. The image data may be video data, graphic data or hybrid data. In an embedded video compression process, image data is compressed by a predefined data rate.

According to the present application, it is found that an occurrence of visible artifacts can be at least significantly reduced by compressing image data by both a video compression mode and a graphic compression mode with the predefined data rate. The video compression mode or compression algorithm is optimized for compressing video data or video content while the graphic compression mode or compression algorithm is optimized for compressing graphic data or graphic content.

The predefined data rate defines a target code size of a compressed data block. It is further found that the target code size can be met in a simple manner by applying quantizing at least one input pixel of the image data such that a code size of the image data block meets the target code size. After detection that the data block does not meet the target code size, one or more input pixels can be quantized. In other words one or more input pixels can be quantized depending on the target code size or data rate. For instance, the LSB (least significant bit) bits from the input pixels can be quantized. Quantizing input pixels includes quantizing the input pixel values of the input pixels. The code size of a compressed data block is adapted to the target code size by simple means.

Normally, the predefined rate is determined by the system-on-chip system level specification. By applying video modeling and graphic modeling, the data amount can be reduced. If the data amount may be still higher than the target data rate, quantization is applied to further reduce the data amount. It may be possible that the quantization methods are different between video mode and graphic mode.

The present application provides a method for embedded video compression, which can ensure high video quality without visible artifacts especially for hybrid image data.

Furthermore, according to another embodiment of the present application, compressing the image data by using the video compression mode and compressing the image data by using the graphic compression mode can be performed in parallel. In other words, two paths, a video compression path and a graphic compression path can be arranged in parallel. Both paths may compress the same image data with the same data rate. However, depending on the data contents, in order to meet the target data rate, data might need to be quantized, and the quantization levels from the two paths may be likely to be different. The quantization level may be a good measurement for coding distortion. The output from the least distortion path may be selected as the encoded data.

According to a further embodiment, at least one input pixel of the image data can be quantized such that a code size of the image data block compressed by using a graphic compression mode meets the target code size. This may be done in case the graphic modeling alone cannot meet the target code size. For instance, the data rate can be defined by the system-on-chip requirements. In this case, the data rate of the graphic compression mode or the code size of the data blocks compressed by using the graphic compression mode can be adapted to the target code size. As mentioned above, the code size can be adapted by quantizing one or more input pixels.

According to another embodiment of the present application the method may comprise detecting the quality of the data block compressed by using the video compression mode and detecting the quality of the data block compressed by using the graphic compression mode, and respectively outputting the image data block having a higher quality. In other words after compressing the image data, the quality or distortion of at least both compressed data blocks can be checked, since both paths compress the input data with the predefined data rate. The quality can be significantly increased since merely the data blocks having a higher quality can be output. The occurrence of visible artifacts due to graphic content compressed by a video compression mode can be prevented.

It is found that detecting the quality of the data block can be performed in an easy manner, in case truncated least significant bits of the data block compressed by using the video compression mode and truncated least significant bits of the data block compressed by using the graphic compression mode are compared. The truncated least significant bits may indicate the level of distortion introduced by the graphic path and video path respectively. More particularly, on top level, if the value of the truncated least significant bits of the data block compressed by using the graphic compression mode is smaller than the value of the truncated least significant bits of the data block compressed by using the video compression mode, the coded package from graphic path can be put out, otherwise, the coded package from video path can be put out.

In addition, according to a further embodiment of the present application, the compressed data block can be provided with a flag depending on the used compression mode. In particular, each compressed data block can be provided with a flag, like a bit flag. The flag may indicate whether the respective data block is compressed by using the video or graphic compression mode. In case the compressed data block is decompressed in subsequent processing steps, a decompression mode must be selected which is suitable for decompression the data block. In particular, for decompressing a data block compressed by video compression mode, a video decompression mode should be selected and for decompressing a data block compressed by graphic compression mode, a graphic decompression mode should be selected. Setting a flag by the respective compression mode may facilitate the detection of the used compression mode significantly.

In another embodiment according to the present application, compressing image data by using the graphic compression mode may comprise receiving input pixels according to a predefined order, detecting whether the current input pixel value differs from the previous input pixel value and calculating the run value of each input pixel value. The order of the pixel can be chosen arbitrarily. Furthermore, it can be detected whether the current input pixel or current input pixel value differs from the previous input pixel or previous input pixel value.

In addition, according to an embodiment, compressing the input data by using the graphic compression mode may comprise determining a run value for at least one particular input pixel. According to a further embodiment, the run value may determine the number of equal pixel occurring successively. By way of example, a generalized run-length coding, like a generalized line-based run-length coding, can be employed. A graphic image may be featured with flat region and strong edges. In run length coding, two values are coded for each block of the repeated pixels, i.e. the number of pixels (“run”) and the pixel value of the input pixel or also merely called input pixel. The run value can be coded by variable length code. Short codes can be used for small “run” values. The pixel value can be initially stored as the original input, i.e. with the input number of bits per sample. The compression of graphic data can be improved.

It is further found that a predefined target code size can be met, in case a quantizing level is defined for quantizing the input pixels, wherein the quantizing level is adapted by checking whether the code size of the data block compressed by using the graphic compression mode meets the target code size. In general, the quantizing level can be defined such that a predefined target code size, which may depend on the data rate, is met. According to an embodiment of the present application, the input pixel or the input pixel value can be quantized at least depending on the quantizing level and the run value of the respective input pixel. More particularly, since the run value and the code size are interrelated, it may be advantageous to take the run value of the input pixel, block or image into account and quantize the input pixel, block or image at least depending on the run value of the respective input pixel, block or image. Furthermore, the run value may be a good indicator of spatial frequency. Thus, it may be advantageous to use the run value to control the pixel value quantization. The run value is especially suitable for taking low spatial frequency errors into account. In a high spatial frequency region, the requirement on bit resolution is low, so that in this region more quantization can be performed.

Another aspect of the present application is a method for embedded video decompression, comprising receiving a data block compressed by using the above-mentioned method for embedded video compression. The method for embedded video decompression comprises determining whether the data block is compressed by using a video compression mode or a graphic compression mode. The method comprises decompressing the data block depending on the determining result.

For instance, a data block compressed by using a video compression mode can be decompressed by using a video decompression mode while a data block compressed by using a graphic compression mode can be decompressed by using a graphic decompression mode. Furthermore, a flag set by the respective compression modes can be used for detecting whether the data block is compressed by using a video compression mode or a graphic compression mode.

A further aspect of the present application is an apparatus for embedded video compression comprising at least one video compression path. The apparatus comprises at least one graphic compression path, wherein the video compression path and the graphic compression path are configured to compress image data into data blocks with a predefined data rate. The predefined data rate defines a target code size of a compressed data block. The graphic compression path comprises a quantizer configured to detect whether a code size of the data block does not meet the target code size, wherein the quantizer is configured to quantize at least one input pixel of the image data in case a code size of the data block does not meet the target code size.

The apparatus may be particular suitable for performing the above stated method for embedded video compression. The video compression path may be configured to execute a video compression mode while the graphic compression path may be configured to execute a graphic compression mode.

According to another embodiment of the present application, the apparatus may comprise a first detector which can be configured to detect the quality of the data block compressed by the video compression path and the quality of the data block compressed by the graphic compression path. In other words the detector may detect the distortion of the compressed data blocks. For instance, truncated least significant bits of the data block compressed by using the video compression mode and truncated least significant bits of the data block compressed by using the graphic compression mode can be detected and compared with each other. The apparatus may provide for improved video quality independent of the received input data.

Furthermore, the apparatus may comprise at least one selector which can be configured to select one of the compressed data blocks depending on the detected quality. The selector may be at least connected with the detector. It may be possible that both selector and detector are realized as a single component. By way of example, the data block comprising a higher quality or less distortion can be selected depending on the comparison between the respective truncated least significant bits. A high video quality can be easily ensured.

Another aspect of the present application is an apparatus for embedded video decompression, comprising a second detector configured to receive the data block compressed by the above mentioned apparatus for embedded video compression, wherein the second detector is configured to determine whether the data block is compressed by a video compression path or by a graphic compression path. The apparatus for embedded video decompression comprises a video decompression path configured to decompress the data block compressed by the video compression path. The apparatus for embedded video decompression comprises a graphic decompression path configured to decompress the data block compressed by the graphic compression path.

A further aspect of the present application is an image processing system comprising at least the above-mentioned apparatus for embedded video compression and the above-mentioned apparatus for embedded video decompression.

Another aspect of the present application is a computer readable medium having a computer program stored thereon. The computer program comprises instructions operable to cause a processor to perform the above-mentioned method for embedded video compression and/or the above-mentioned method for embedded video decompression.

These and other aspects of the present patent application become apparent from and will be elucidated with reference to the following Figures. The features of the present application and of its exemplary embodiments as presented above are understood to be disclosed also in all possible combinations with each other.

### BRIEF DESCRIPTION OF THE DRAWINGS

In the Figures show:

FIG. 1 a diagram of the probability distribution for video contents,

FIG. 2 a diagram of the probability distribution for graphic contents,

FIG. 3 an embodiment of the apparatus for embedded video compression according to the present application,

FIG. 4 an embodiment of the apparatus for embedded video decompression according to the present application,

FIG. 5 a flowchart of an embodiment of the method for embedded video compression according to the present application,

FIG. 6 a flowchart of an embodiment of the method for embedded video decompression according to the present application,

FIG. 7 a flowchart of a first embodiment of the method for embedded graphic compression according to the present application,

FIG. 8 a flowchart of a second embodiment of the method for embedded graphic compression according to the present application.

Like reference numerals in different Figures indicate like elements.

### DETAILED DESCRIPTION OF THE DRAWINGS

In the following detailed description of the present application, exemplary embodiments of the present application will describe and point a method for embedded video compression and decompression and apparatuses for performing these methods, which ensure an improved video quality without visible artifacts especially for hybrid image data.

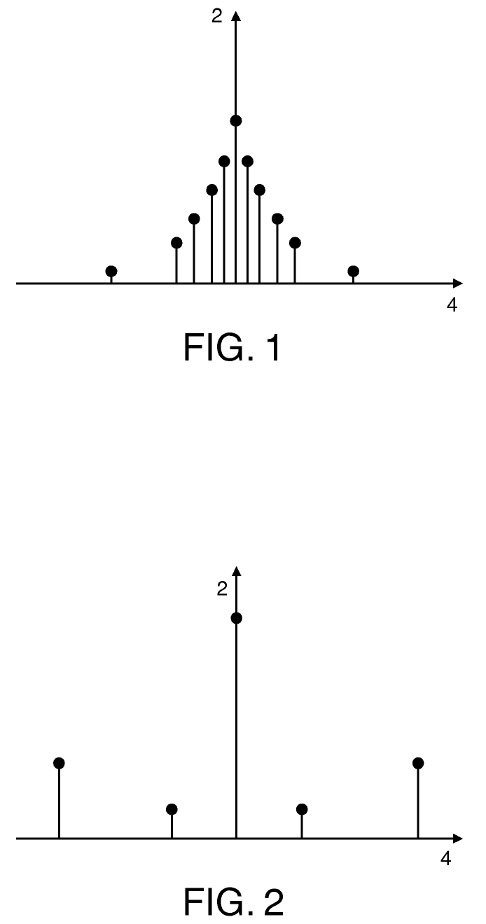

At first, the differences between video content and graphic content responsible for the issues occurring during processing these contents are explained by the aid of FIGS. 1 and 2. While FIG. 1 shows a diagram of the probability distribution for video contents, FIG. 2 shows a diagram of the probability distribution for graphic contents. Thereby, reference sign 2 indicates the probability and reference sign 4 indicates the prediction error.

It is a widely accepted observation that the global statistics of residuals from a fixed predictor in continuous-tone images are well modelled by a two-sided geometric distribution, which means the probability of a small value may be much higher than the probability of large value. Since Golomb coding or Colomb-Rice mechanism codes provide small values with small code size and large values with large code size, the prediction residua of video image can be coded efficiently by these codes. However, graphic image may comprise a different characteristic. A graphic image or content generally may have large flat area. Thus, the value difference between neighboring pixels generally may be large, too.

As can be seen from FIG. 1, the probability for increasing prediction error falls off relatively fast. Contrary to this, the probability for increasing prediction error increases after a first reduction according to FIG. 2.

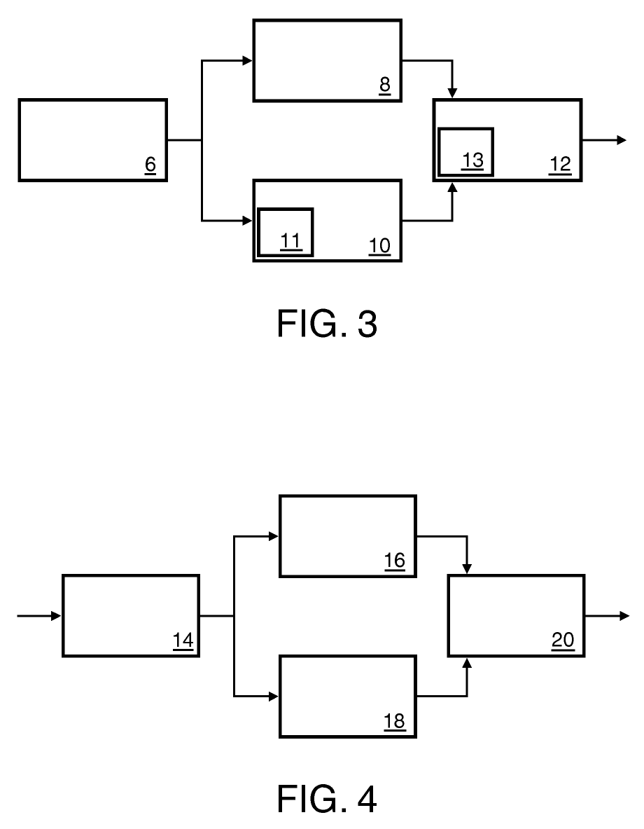

FIG. 3 shows a simplified embodiment of the apparatus for embedded video compression according to the present application. The illustrated apparatus comprises an image data source 6. The image data source 6 may be any device being able to generate image data. More particularly, the image data source 6 may generate video content as well as graphic video content.

Furthermore, a video compression path 8 and a graphic compression path 10 are provided. The image data generated by the image data source 6 are processed by both units 8 and 10 with a predefined data rate resulting in data blocks comprising the same code size. The code size may depend on the data rate. In other words processing the image data can be performed in parallel. These units 8 and 10 may differ in their processing mode. More particularly, the video compression path 8 may use a mode or an algorithm optimized for video content while the graphic compression path 10 may use a mode or an algorithm optimized for graphic content.

In addition, the graphic compression path 10 may comprise a quantizer 11. It may be possible that the data rate or code size is established by the video compression path 8 and video compression mode respectively. For meeting this code size also during compressing the image data by using the graphic compression mode, the graphic compression path may comprise a quantizer 11 arranged for quantizing input pixels of the input data. Details will be elucidated subsequently.

The respective compressed data blocks are forwarded to a first detector 12. The first detector 12 may be configured to detect the quality or distortion of the compressed data blocks. Thereby, detecting the quality or distortion can be performed by comparing truncated bits. Depending on the comparison, the selector 13 selects the compressed data block comprising a higher quality and the selector 13 may forward the respective data block to further processing or storing units. A detailed elucidation of the graphic compression algorithm and the process performed by the first detector 12 will follow subsequently.

In FIG. 4 a simplified embodiment of the apparatus for embedded video decompression according to the present application is shown. According to FIG. 4, the depicted apparatus may be configured to receive compressed input data. In particular, the apparatus receives the compressed data block output by the first detector 12 shown in FIG. 3. It shall be understood that further components, such as suitable processing, storing or buffering units can be arranged between the output of the first detector 12 of the video compression apparatus and the input of the apparatus for video decompression according to FIG. 4.

In more detail, the compressed data is received by a second detector 14. This detector 14 is configured to detect whether the compressed data has been compressed by the video compression path 8 or the graphic compression path 10. Depending on the detection result, the respective data is forwarded to a video decompression path 16 or a graphic decompression path 18 for decompressing. Also the decompression paths 16 and 18 may operate according as respectively optimized decompression modes or algorithms. It shall be understood that the decompression algorithms may depend on the respective used compression algorithm.

The decompressed data can be fed to a suitable switching unit 20 configured to connect the respective compression path, i.e. video decompression path 16 or a graphic decompression path 18, with further processing devices.

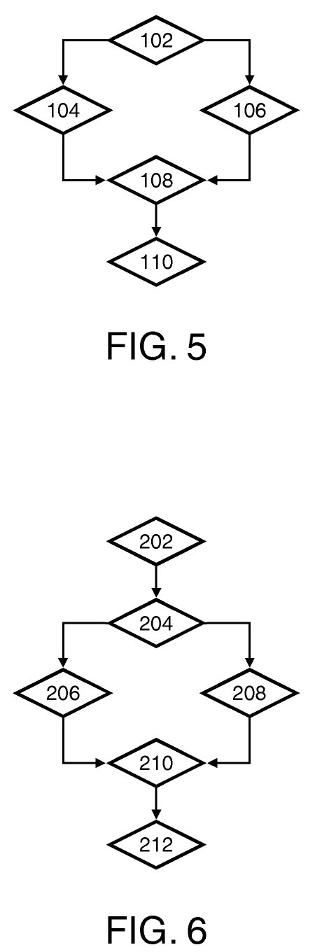

In the following the method for embedded video compression according to the present application will be elucidated by means of FIGS. 3 and 5. FIG. 5 shows a flowchart of a simplified embodiment of the method for embedded video compression according to the present application.

In a first step 102 image data, like regular video data, graphic data or hybrid data comprising video and graphic content can be received. In particular, this image data can be received by both the video compression path 8 and the graphic compression path 10.

In following steps 104 or 106, the received image data can be compressed by the video compression path 8 and a graphic compression path 10 in parallel. The graphic compression path 10, which can be added to an already existing video compression path 8, can be operated with the same compression ratio as the video compression path 8. However, the mode or algorithm used by the graphic compression path 10 is optimally designed for meeting the requirements of graphic data. Both compression path 8 and 10 may generate data blocks comprising the same content and same code size.

Furthermore, a flag can be set by each compression path 8 and 10 in step 104 and 106 respectively. The flag can be used for decompressing, as will be elucidated subsequently. For instance, a bit flag can be set, wherein the value ‘1’ may indicate a graphic compressed data block while the value ‘0’ may indicate a video compressed data block. It shall be understood that a plurality of alternative flags and flag values can be also used.

Then, in a next step 108, it can be detected which compressed data packet or compressed data block comprises less distortion. In particular, the first detector 12 may be configured to analyze both data blocks. The data blocks may be received at the same time since both compression modes use the same data rate. Thus, two data blocks comprising the same image content compressed by tow different compression modes are compared with each other in view of their quality or distortion.

According to the present application, the first detector 12 may truncate the least significant bits (LSB) from the data packet sent by the video compression path 8 and may truncate the least significant bits (LSB) from the data packet sent by the graphic compression path 10. The maximum value of the truncated LSB bits can be called Graphic_LSB_cut. Similarly, the maximum value of the truncated LSB bits from the video path can be called Video_LSB_cut. It is found that Graphic_LSB_cut and Video_LSB_cut may be preferably used to determine the quality or distortion of the data block, since Graphic_LSB_cut and Video_LSB_cut may indicate the level of distortion introduced by the graphic compression path 10 and video compression path 8 respectively. On top level, if the Graphic_LSB_cut is smaller than Video_LSB_cut, the coded package from graphic compression path 10 will be sent out in step 110 by the selector 13, otherwise, the coded package from video compression path 8 will be sent out in step 110.

After pointing out the compression process according to the present application an elucidation of the method for embedded video decompression according to the present application will follow by means of FIGS. 4 and 6. FIG. 6 shows a flowchart of a simplified embodiment of the method for embedded video decompression according to the present application.

In a first step 202 image data can be received by the decompression apparatus according to FIG. 4. More particularly, the data block being compressed in particular by the apparatus according to FIG. 3 can be received by a second detector 14.

The second detector 14 determines in step 204 which kind of compressed data is received. As previously mentioned, each data block generated by the video compression path 8 and the graphic compression path 10 can be provided with a flag. The second detector 14 is configured to determine whether the received compressed data block is a block compressed by the video compression path 8 or the graphic compression path 10 by analyzing the value of the flag. According to the example stated above, the second detector 14 sends a data block provided with a flag having the value ‘0’ to the video decompression path 16 and a data block provided with a flag having the value ‘1’ to the graphic decompression path 18.

In following steps 206 and 208, the compressed data blocks are decompressed either by the video decompression path 16 or the graphic decompression path 18. In a next step 110 the respective decompression path 16 or 18 is connected to the further processing units. For instance, switching the output to the respective decompression path 16 or 18 can be performed depending on the flag of the data block. Then the decompressed data is output in step 212.

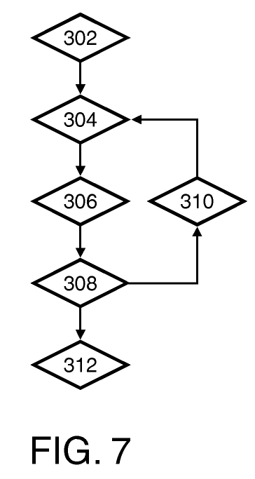

FIG. 7 shows a flowchart of a first simplified embodiment of the method for embedded graphic compression according to the present application. In a first step 302 a run value can be calculated. Then the input pixel and input pixel value respectively can be quantized if needed (step 304). Subsequently, the run value and the possibly quantized pixel are coded or compressed in step 306. Furthermore, as previously mentioned, flag can be set. A data block comprising the coded or compressed bits and the flag is generated.

In addition, the code size of the compressed or coded data block can be determined and it can be compared with the target code size. Depending on the comparison the data block can be fed to further processing or storing units in step 312 or the quantizing level can be adapted in step 310 and it can be continued with step 304.

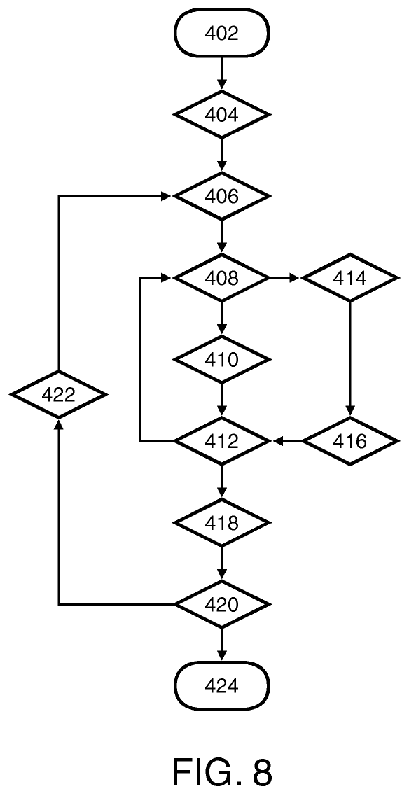

FIG. 8 shows a flowchart of a second simplified embodiment of the method for embedded graphic compression according to the present application. This flowchart is a more detailed illustration of the above state embedded compression method. After the graphic compression process is started in a first step 402, the quantizing level can be initialized with the value ‘0’ in a next step 404.

Then, in step 404, the run value can be initialized by the value ‘1’ and the previous pixel value can be set to the first received pixel value or input pixel in step 404. In addition, the quantizing level can be stored. Storing the quantizing level can be required since the quantizing level can be changed in a previously performed step, as will be pointed out subsequently.

Afterwards, it is checked whether the current received pixel value is equal to the previous pixel value (step 408). It shall be understood that in the first cycle of the present process, the current pixel value is the first pixel value, and thus, the current pixel value is equal to the previous pixel value. So this step may be obsolete in the first cycle.

In the case, the current input pixel and previous input pixel are equal, the run value can be incremented by one and the next input pixel of the image data can be received (step 410). In particular, the current pixel can be set to the next pixel. Then, in step 412, it can be checked whether the current pixel is the last pixel to be processed. In case the current pixel is not the last pixel, it is continued with step 408. As stated above, in step 408, it is checked whether the current pixel is equal with the previous pixel.

If both the current pixel value and the previous pixel value differ from each other, in a next step 414, the run value can be stored. Furthermore, the previous pixel value is quantized according to the quantizing level and the run value. More particularly, the previous pixel value can be quantized by

quantizing level−ceil(run/2), a)

wherein the function “ceil” represent a rounding function to the next integer. The equation a ensures that the quantization of pixel value is depending on the Run value. This may be advantageous since the run value which is used to control the pixel value quantization, may be a good indicator of spatial frequency. It shall be understood that, according to other variants of the present application, another quantizing algorithm or another divisor can be chosen.

Furthermore, the quantized pixel value can be stored in step 414. In the next step 416, the previous pixel value is set to the current pixel value, the run value is initialized with the value ‘1’ and the next input pixel value is received. Or in other words, the current input pixel value is set to the next input pixel value.

In case, in the following step 412 it is determined that the current pixel is also the last pixel, it is continued with step 418. This step 418 may be similar to step 414. The run value can be stored, the previous pixel can be quantized and then the quantized value can be stored.

Subsequently, the code size of the stored or coded data block is checked. More particularly, to meet the target code size, the current code size is compared with the target code size in step 420. If the code size of the stored or coded data block is smaller than the target code size, the quantizing level can be incremented in step 422 and is can be continued with step 406. Otherwise, the present process or method can be terminated in the last step 424.

Furthermore, it is readily clear for a person skilled in the art that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electro-magnetic or optic type and may be read and executed by a processor, such as for instance a microprocessor. To this end, the processor and the storage medium may be coupled to interchange information, or the storage medium may be included in the processor.

1. A method for embedded video compression, comprising:
receiving image data,
compressing the image data into compressed data blocks with a predefined data rate by using a video compression mode,
compressing the image data into compressed data blocks with the predefined data rate by using a graphic compression mode,
wherein the predefined data rate defines a target code size of a compressed data block,
detecting whether a code size of the data block does not meet the target code size, and
quantizing at least one input pixel of the image data in case a code size of the data block does not meet the target code size.

2. The method according to claim 1, wherein compressing the image data by using the video compression mode and compressing the image data by using the graphic compression mode is performed in parallel.

3. The method according to claim 1, wherein quantizing at least one input pixel of the image data such that a code size of the image data block compressed by using a graphic compression mode meets the target code size.

4. The method according to claim 1, further comprising:
detecting the quality of the data block compressed by using the video compression mode and detecting the quality of the data block compressed by using the graphic compression mode, and
respectively outputting the image data block having a higher quality.

5. The method according to claim 4, wherein detecting the quality of the data block comprises comparing truncated least significant bits of the data block compressed by using the video compression mode and truncated least significant bits of the data block compressed by using the graphic compression mode.

6. The method according to claim 1, wherein compressing the image data by using the graphic compression mode comprises receiving input pixels according to a predefined order, detecting whether the current input pixel value differs from the previous input pixel value and calculating the run value of each input pixel value.

7. The method according to claim 1, further comprising:
defining a quantizing level for quantizing the input pixels,
wherein the quantizing level is adapted by checking whether the code size of the data block compressed by using the graphic compression mode meets the target code size.

8. The method according to claim 7, wherein the input pixel is quantized at least depending on the run value of the input pixel.

9. A method for embedded video decompression, comprising:
receiving a data block compressed by using the method for embedded video compression according to the claim 1,
determining whether the data block is compressed by using a video compression mode or a graphic compression mode, and
decompressing the data block depending on the determining result.

10. An apparatus for embedded video compression, comprising:
at least one video compression path, and
at least one graphic compression path,
wherein the video compression path and the graphic compression path are configured to compress image data into data blocks with a predefined data rate,
wherein the predefined data rate defines a target code size of a compressed data block, and
wherein the graphic compression path comprises a quantizer configured to detect whether a code size of the data block does not meet the target code size, wherein
the quantizer is configured to quantize at least one input pixel of the image data in case a code size of the data block does not meet the target code size.

11. The apparatus according to claim 10, further comprising a first detector configured to detect the quality of the data block compressed by the video compression path and the quality of the data block compressed by the graphic compression path.

12. The apparatus according to claim 10, further comprising at least one selector configured to select one of the compressed data blocks depending on the detected quality.

13. An apparatus for embedded video decompression, comprising:
a second detector configured to receive the data block compressed by the apparatus for embedded video compression according to claim 13,
wherein the second detector is configured to determine whether the data block is compressed by a video compression path or by a graphic compression path,
a video decompression path configured to decompress the data block compressed by the video compression path, and
a graphic decompression path configured to decompress the data block compressed by the graphic compression path.

14. An image processing system comprising at least the apparatus for embedded video compression according to claim 10 and the apparatus for embedded video decompression according to claim 13.

15. A non-transitory computer readable medium having a computer program stored thereon, the computer program comprising:
instructions operable to cause a processor to perform a method according to claim 1.
